(19) United States
(12) Patent Application Publication
(10) Pub. No.: US 2025/0380249 A1
(43) Pub. Date: Dec. 11, 2025

(54) CARRIER BANDWIDTH AND BANDWIDTH PART CONFIGURATION FOR FRAGMENTED CARRIERS

(71) Applicant: Apple Inc., Cupertino, CA (US)

(72) Inventors: Xiang Chen, Campbell, CA (US); Dawei Zhang, Saratoga, CA (US); Haitong Sun, Saratoga, CA (US); Jie Cui, San Jose, CA (US); Qiming Li, Beijing (CN); Yang Tang, San Jose, CA (US); Yuexia Song, Beijing (CN)

(73) Assignee: Apple Inc., Cupertino, CA (US)

(21) Appl. No.: 19/201,831

(22) Filed: May 7, 2025

Related U.S. Application Data
(60) Provisional application No. 63/657,589, filed on Jun. 7, 2024.

(51) Int. Cl. H04W 72/0453

(52) U.S. Cl. CPC H04W 72/0453

(57) ABSTRACT

The present application relates to devices and components including apparatus, systems, and methods for configuring carrier bandwidths and bandwidth parts for fragmented carriers in wireless communication systems.

### CROSS-REFERENCE TO RELATED APPLICATION

This application claims the benefit of U.S. Provisional Patent Application No. 63/657,589, filed on Jun. 7, 2024, which is herein incorporated by reference in its entirety for all purposes.

### TECHNICAL FIELD

The present application relates to the field of wireless technologies and, in particular, to carrier bandwidth and bandwidth part configuration for fragmented carriers.

### BACKGROUND

Third Generation Partnership Project (3GPP) networks provide for user equipments (UEs) to utilize carriers for communicating with the networks. Carriers of a network can be assigned to different user equipments (UEs), where a UE can utilize the corresponding assigned carriers to communicate with the network. Different carriers can be assigned to different UEs within a same area, where the different UEs may utilize the corresponding assigned carriers to simultaneously communicate with the network.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates example fragmented carrier arrangements in accordance with some embodiments.

FIG. 5 illustrates an example carrier gap arrangement in accordance with some embodiments.

FIG. 6 illustrates an example frequency block arrangement in accordance with some embodiments.

FIG. 7 illustrates tables with example minimum guard band (GB) requirements in accordance with some embodiments.

FIG. 8 illustrates example frequency block arrangements in accordance with some embodiments.

FIG. 9 illustrates an example frequency block arrangement in accordance with some embodiments.

FIG. 10 illustrates an example frequency block arrangement in accordance with some embodiments.

FIG. 11 illustrates an example procedure for generating configuration information in accordance with some embodiments.

FIG. 12 illustrates an example procedure in accordance with some embodiments.

FIG. 13 illustrates an example procedure in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

Third Generation Partnership Project (3GPP) networks are developing to support fragmented carrier arrangements for user equipments (UEs). However, a challenge is how to configure the fragmented carrier arrangement for a UE, including configuring fragmented carriers in a bandwidth part (BWP) of the UE. Approaches described herein may be utilized for configuring fragmented carriers in BWPs of the UE.

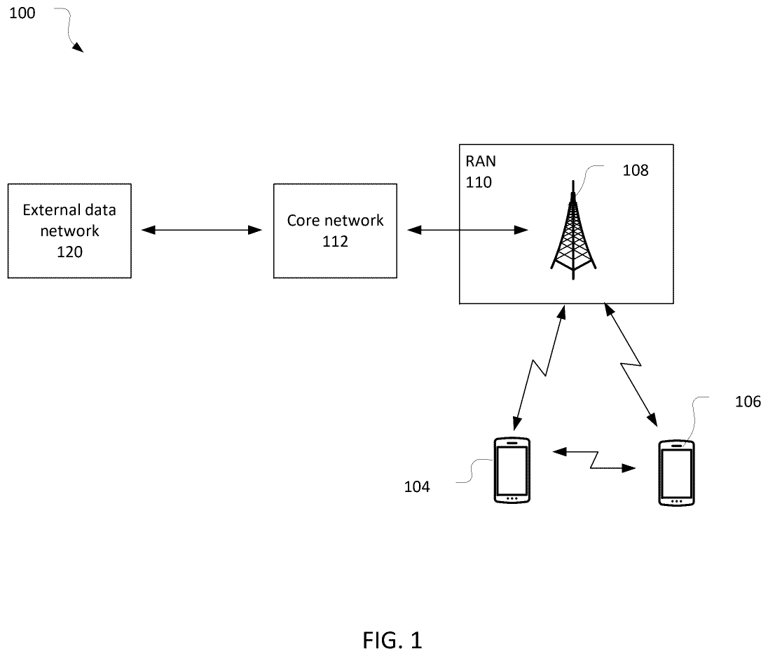

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

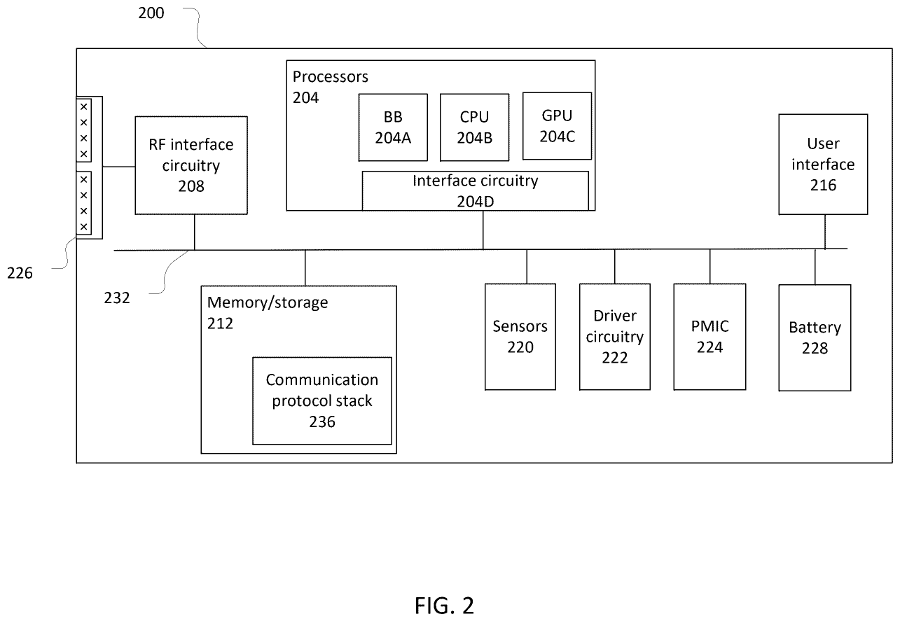

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

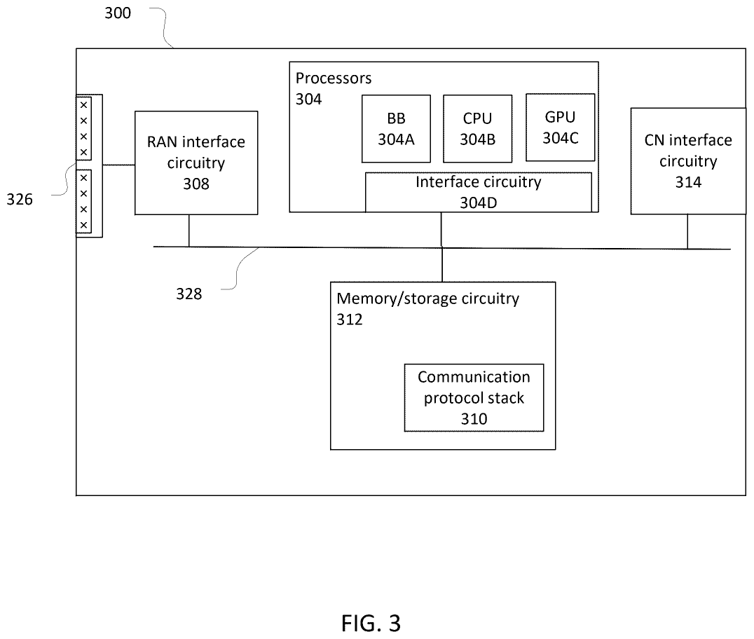

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

In release 19 (R19), fragmented carriers in the downlink (DL) may be supported. How to consider fragmented intra-band blocks as a single component carrier (CC) in the DL may be addressed. The scope may be limited to frequency division duplex (FDD) bands, where individual DL bandwidth may be limited to less than or equal to 100 megahertz (MHz). The feasibility of using a single reception (Rx) chain per fragmented FDD band may be considered, while the near-far problem and unwanted emissions implications may be considered.

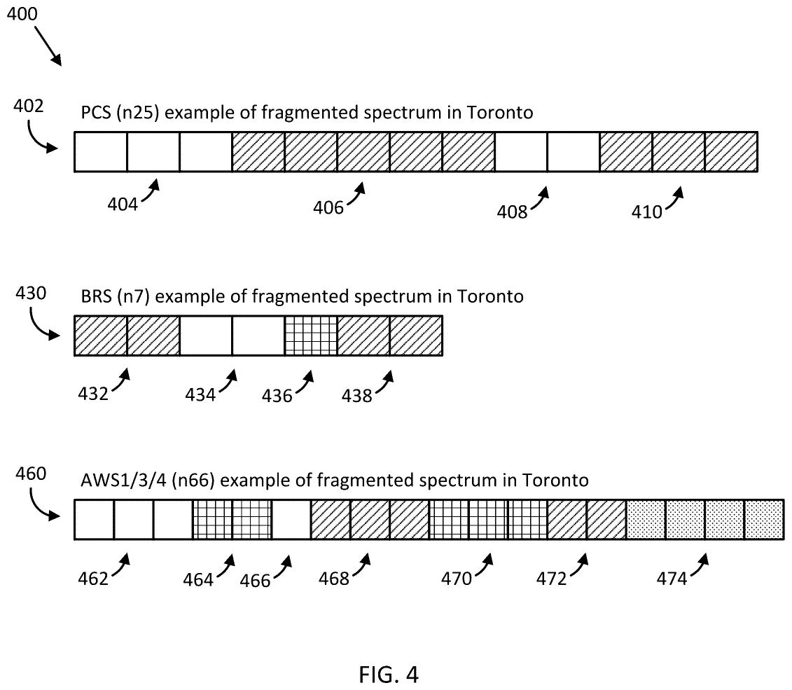

FIG. 4 illustrates example fragmented carrier arrangements 400 in accordance with some embodiments. For example, the arrangements 400 illustrate some example carrier assignments with non-contiguous carrier groups being assigned to a same UE. Each of the block within the illustrated arrangements 400 represent a 5 MHz spectrum, where blocks with the same fill represent carrier(s) assigned to a same UE. For example, a same fill indicates spectrum access for a same operator. Each of the blocks is 5 MHz wide in the illustrated embodiment.

The arrangements 400 include a first fragmented carrier arrangement 402. The first arrangement 402 may include a personal communications services (PCS) (n25) example of segmented spectrum, which can be for Toronto in the illustrated embodiment. The first arrangement 402 includes a first group of carrier(s) 404, a second group of carrier(s) 406, a third group of carrier(s) 408, and a fourth group of carrier(s) 410. The first group of carrier(s) 404 and the third group of carrier(s) 408 may be assigned to a first operator (as illustrated by the corresponding blocks having no fill), which can assign the first group of carrier(s) 404 and the third group of carrier(s) 408 to a first UE. The second group of carrier(s) 406 and the fourth group of carrier(s) 410 may be assigned to a second operator (as illustrated by the corresponding blocks having a diagonal line fill), which can assign the second group of carrier(s) 406 and the fourth group of carrier(s) 410 to a second UE.

The first group of carrier(s) 404 and the third group of carrier(s) 408 are separated by the second group of carrier(s) 406, thereby causing the first group of carrier(s) 404 and the third group of carrier(s) 408 to be non-contiguous. As both the first group of carrier(s) 404 and the third group of carrier(s) 408 are assigned to the first operator, the carrier(s) may be a fragmented carrier assignment to the first operator. The second group of carrier(s) 406 and the fourth group of carrier(s) 410 are separated by the third group of carrier(s) 408, thereby causing the second group of carrier(s) 406 and the fourth group of carrier(s) 410 to be non-contiguous. As both the second group of carrier(s) 406 and the fourth group of carrier(s) 410 are assigned to the second operator, the carrier(s) may be a fragmented carrier assignment to the second operator. The carrier(s) between the fragmented carrier(s) in the fragmented carrier assignments could cause interference with the fragmented carrier(s). Legacy network implementations did not address this interference possibility for fragmented carrier(s).

The arrangements 400 include a second fragmented carrier arrangement 430. The second arrangement 430 may include a broadband radio services (BRS) (n7) example of segmented spectrum, which can be for Toronto in the illustrated embodiment. The second arrangement 430 includes a first group of carrier(s) 432, a second group of carrier(s) 434, a third group of carrier(s) 436, and a fourth group of carrier(s) 438. The first group of carrier(s) 432 and the fourth group of carrier(s) 438 may be assigned to a first operator (as illustrated by the corresponding blocks having diagonal line fill), which can assign the first group of carrier(s) 432 and the fourth group of carrier(s) 438 to a first UE. The second group of carrier(s) 434 may be assigned to a second operator (as illustrated by the corresponding blocks having no fill), which can assign the second group of carrier(s) 434 to a second UE. The third group of carrier(s) 436 may be assigned to a third operator (as illustrated by the corresponding blocks having a crosshatch fill), which can assign the third group of carrier(s) 436 to a third UE.

The first group of carrier(s) 432 and the fourth group of carrier(s) 438 are separated by the second group of carrier(s) 434 and the third group of carrier(s) 436, thereby causing the first group of carrier(s) 432 and the fourth group of carrier(s) 438 to be non-contiguous. As both the first group of carrier(s) 432 and the fourth group of carrier(s) 438 are assigned to the first operator, the carrier(s) may be a fragmented carrier assignment to the first operator. The carrier(s) between the fragmented carriers in the fragmented carrier assignments could cause interference with the fragmented carriers. Legacy network implementations did not address this interference possibility for fragmented carriers.

The arrangements 400 include a third fragmented carrier arrangement 460. The third arrangement 460 may include an advanced wireless services (AWS) 1/3/4 (n66) example of segmented spectrum, which can be for Toronto in the illustrated embodiment. The third arrangement 460 includes a first group of carrier(s) 462, a second group of carrier(s) 464, a third group of carrier(s) 466, a fourth group of carrier(s) 468, a fifth group of carrier(s) 470, a sixth group of carrier(s) 472, and a seventh group of carrier(s) 474. The first group of carrier(s) 462 and the third group of carrier(s) 466 may be assigned to a first operator (as illustrated by the corresponding blocks having no fill), which can assign the first group of carrier(s) 462 and the third group of carrier(s) 466 to a first UE. The second group of carrier(s) 464 and the fifth group of carrier(s) 470 may be assigned to a second operator (as illustrated by the corresponding blocks having a crosshatch fill), which can assign the second group of carrier(s) 464 and the fifth group of carrier(s) 470 to a second UE. The fourth group of carrier(s) 468 and the sixth group of carrier(s) 472 may be assigned to a third operator (as illustrated by the corresponding blocks having a diagonal line fill), which can assign the fourth group of carrier(s) 468 and the sixth group of carrier(s) 472 to a third UE. The seventh group of carrier(s) 474 may be assigned to a fourth operator (as illustrated by the corresponding blocks having a dotted fill), which can assign the seventh group of carrier(s) 474 to a fourth UE.

The first group of carrier(s) 462 and the third group of carrier(s) 466 are separated by the second group of carrier(s) 464, thereby causing the first group of carrier(s) 462 and the third group of carrier(s) 466 to be non-contiguous. As both the first group of carrier(s) 462 and the third group of carrier(s) 466 are assigned to the first operator, the carriers may be a fragmented carrier assignment to the first operator. The second group of carrier(s) 464 and the fifth group of carrier(s) 470 are separated by the third group of carrier(s) 466 and the fourth group of carrier(s) 468, thereby causing the second group of carrier(s) 464 and the fifth group of carrier(s) 470 to be non-contiguous. As both the second group of carrier(s) 464 and the fifth group of carrier(s) 470 are assigned to the second operator, the carriers may be a fragmented carrier assignment to the second operator. The fourth group of carrier(s) 468 and the sixth group of carrier(s) 472 are separated by the fifth group of carrier(s) 470, thereby causing the fourth group of carrier(s) 468 and the sixth group of carrier(s) 472 to be non-contiguous. As both the fourth group of carrier(s) 468 and the sixth group of carrier(s) 472 are assigned to the third operator, the carriers may be a fragmented carrier assignment to the third operator. The carriers between the fragmented carriers in the fragmented carrier assignments could cause interference with the fragmented carriers. Legacy network implementations did not address this interference possibility for fragmented carriers.

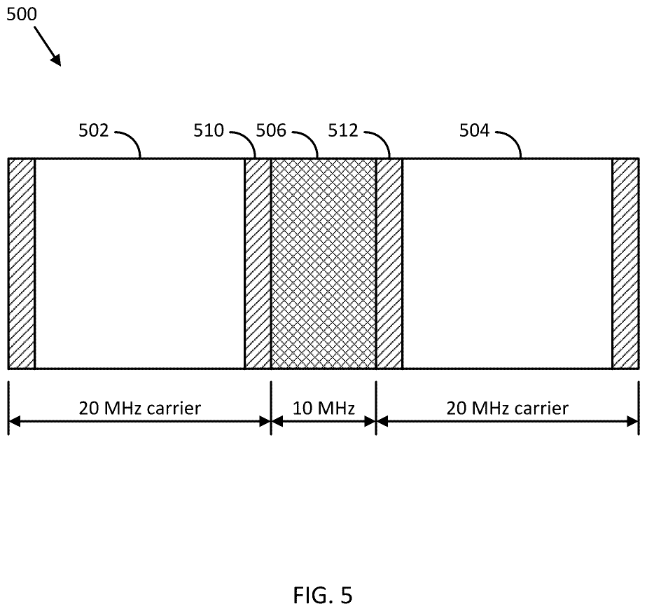

FIG. 5 illustrates an example carrier gap arrangement 500 in accordance with some embodiments. The arrangement 500 illustrates an example of a fragment carrier assignment with a gap between the fragmented carriers.

The arrangement 500 includes a first group of carrier(s) 502 and a second group of carrier(s) 504. The first group of carrier(s) 502 and the second group of carrier(s) 504 may be assigned to a first UE. Each of the first group of carrier(s) 502 and the second group of carrier(s) 504 may include one or more carriers. In the illustrated embodiment, each of the first group of carrier(s) 502 and the second group of carrier(s) 504 may include a 20 MHz carrier. In the illustrated embodiment, the first group of carrier(s) 502 may include four carriers and the second group of carrier(s) 504 may include four carriers.

The arrangement 500 may include a gap 506 between the first group of carrier(s) 502 and the second group of carrier(s) 504. In the illustrated embodiment, the gap 506 may be 10 MHz. There is likely other operators operating in the gap between the two adjacent frequency blocks, presenting strong interferer/blocker. Carrier(s) within the gap may not be assigned to first UE. In some embodiments, a portion of the carrier(s) within the gap 506 may be assigned to other UEs. For example, the portion of the carrier(s) may be assigned to a second UE in the illustrated embodiment. The portion of the carrier(s) assigned to another UE may be referred to as an interferer and/or blocker. Accordingly, the arrangement 500 may have an interferer/blocker in the gap 506.

The arrangement 500 may include guard bands in the first group of carrier(s) 502, and/or the second group of carrier(s) 504. For example, the first group of carrier(s) 502 and the second group of carrier(s) 504 may include guard bands at the edges of the carriers adjacent to the gap 506 that includes the interferer/blocker. The first group of carrier(s) 502 includes a first guard band 510 at an edge of the first group of carrier(s) 502 adjacent to the interferer/blocker, and the second group of carrier(s) 504 includes a second guard band 512 at an edge of the second group of carrier(s) 504 adjacent to the interferer/blocker in the illustrated embodiment. The carrier(s) within the guard bands may be unassigned and may provide some protection from interference between the interferer/blocker, the first group of carrier(s) 502, and/or the second group of carrier(s) 504.

Bandwidth Part (BWP) concept has been introduced in release 15 (R15) for new radio (NR) to allow a UE to only support smaller channel bandwidth than system bandwidth supported by a base station (BS) and also save power. A BWP is a subset of contiguous common resource blocks (RBs). For a UE, while up to four BWP can be configured for a serving cell, there is at most one active downlink (DL) BWP and at most one active uplink (UL) BWP at a given time.

However, the frequency gap between the two blocks may not be exactly multiple RBs. For example, say two 5 MHz blocks are separated by another 5 MHZ, the frequency gap is 10 MHz, approximately 55.56 RBs (subcarrier spacing (SCS)=15 kilohertz (kHz)) or approximately 27.78 RBs (SCS=30 kHz).

In this disclosure, carrier bandwidth and BWP configurations for supporting fragmented carrier are described. For a first approach (which may be referred to as “Approach 1”), a configuration may include a single configured carrier bandwidth, a single active BWP, and may implement a block center frequency shift. For a second approach (which may be referred to as “Approach 2”), a configuration may include a single configured carrier bandwidth, multiple active BWPs, and may implement block center frequency shift. For a third approach (which may be referred to as “Approach 3”), a configuration may include multiple configured carrier bandwidths, multiple active BWPs, may not implement block center frequency shift.

For the first approach, a single BWP may be configured to cover both frequency blocks (which may be designated as Block A and Block B throughout this disclosure).

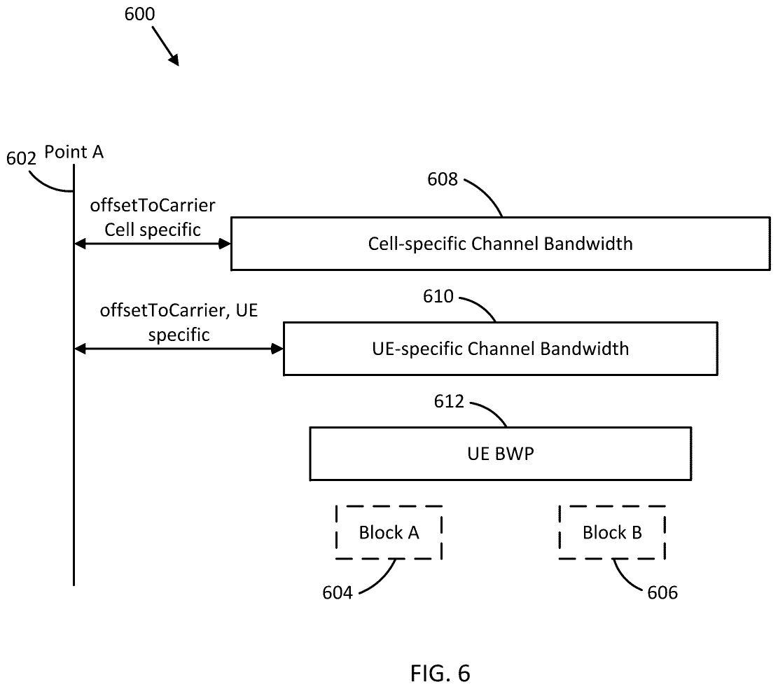

FIG. 6 illustrates an example frequency block arrangement 600 in accordance with some embodiments. For example, the arrangement 600 illustrates an example of a single BWP part being configured to cover two non-contiguous frequency blocks in accordance with the first approach. The arrangement 600 illustrates a configuration that may be implemented related to a UE.

The arrangement 600 may include a reference point 602. The reference point 602 may be referred to as point A. The reference point 602 may be a point in which bandwidth configurations related to the UE are referenced. The reference point 602 may be utilized by a base station and/or a connected UE for coordinating scheduling of transmission of messages.

The arrangement 600 includes a first frequency block 604 and a second frequency block 606. The first frequency block 604 and the second frequency block 606 may be non-contiguous. The first frequency block 604 and the second frequency block 606 may be configurable for the UE, where the UE may utilize the frequencies within the first frequency block 604 and/or the second frequency block 606 when the blocks are configured to the UE.

The arrangement 600 includes a cell-specific channel bandwidth 608. The cell-specific channel bandwidth 608 may define a bandwidth for broadcasting by a base station hosting a cell. For example, the base station may transmit messages within the cell-specific channel bandwidth 608. The cell-specific channel bandwidth 608 may be offset from the reference point 602 by an offset to carrier cell specific value, which can be defined by an offset to carrier cell specific field of an information element.

The arrangement 600 includes a UE-specific channel bandwidth 610. The UE-specific channel bandwidth 610 may be a bandwidth that was configured for the particular UE. The UE-specific channel bandwidth 610 may be fully contained within the cell-specific channel bandwidth 608. The UE-specific channel bandwidth 610 may be offset from the reference point 602 by an offset to carrier UE specific value, which can be defined by an offset to carrier UE specific field of an information element.

The arrangement 600 includes a UE BWP 612. The UE BWP 612 may be configured for use by the UE. The UE BWP 612 may be fully contained within the UE-specific channel bandwidth 610 and may be smaller than the UE-specific channel bandwidth 610.

For the first approach, the UE BWP 612 may be configured to cover both the first frequency block 604 and the second frequency block 606. For example, the frequencies within the first frequency block 604 and the second frequency block 606 may also be within the UE BWP 612. Further, the UE-specific channel bandwidth 610 may cover both the first frequency block 604 and the second frequency block 606. The base station may configure the UE with UE BWP 612 that covers both the first frequency block 604 and the second frequency block 606 in the first approach.

Block A's center frequency may fall on the 100 kHz channel raster and Block B's center frequency may be moved slightly to ensure the gap is multiple of RB bandwidth. Because Block B is moved closer to Block C (belonging to another operator), coexistence needs to be ensured, i.e., need to ensure guard band (GB) on Block B can still meet the minimum GB requirement.

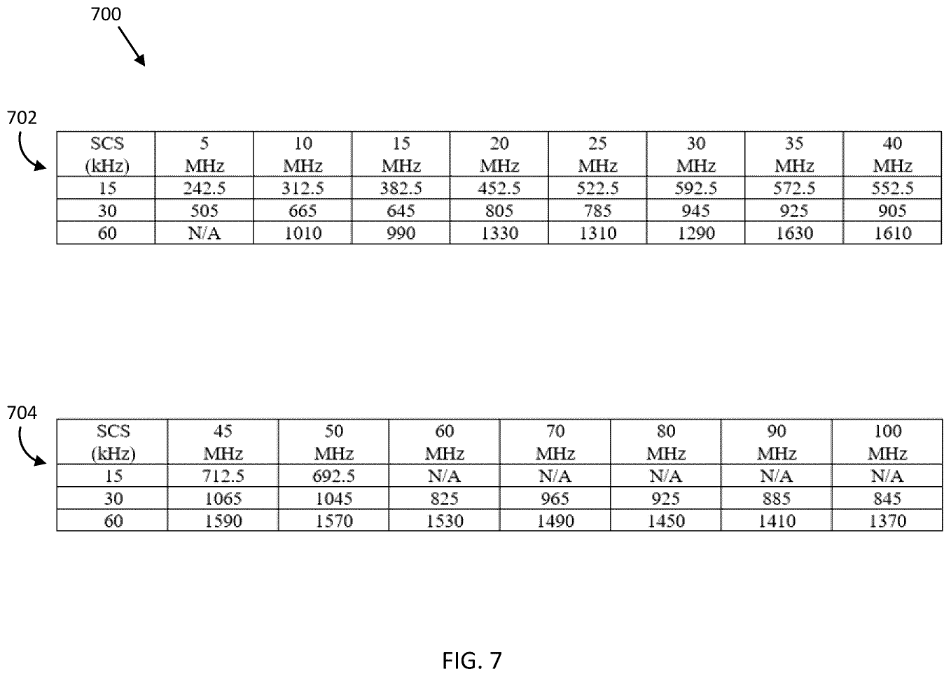

FIG. 7 illustrates tables 700 with example minimum GB requirements in accordance with some embodiments. In particular, the tables 700 includes a first table 702 illustrating a first portion of minimum GB requirements and a second table 704 illustrating a second portion of minimum GB requirements. The tables 700 illustrate minimum GBs that may be used for each UE channel bandwidth ad SCS (kHz). For coexistence, the corresponding minimum GB may be ensured in some embodiments.

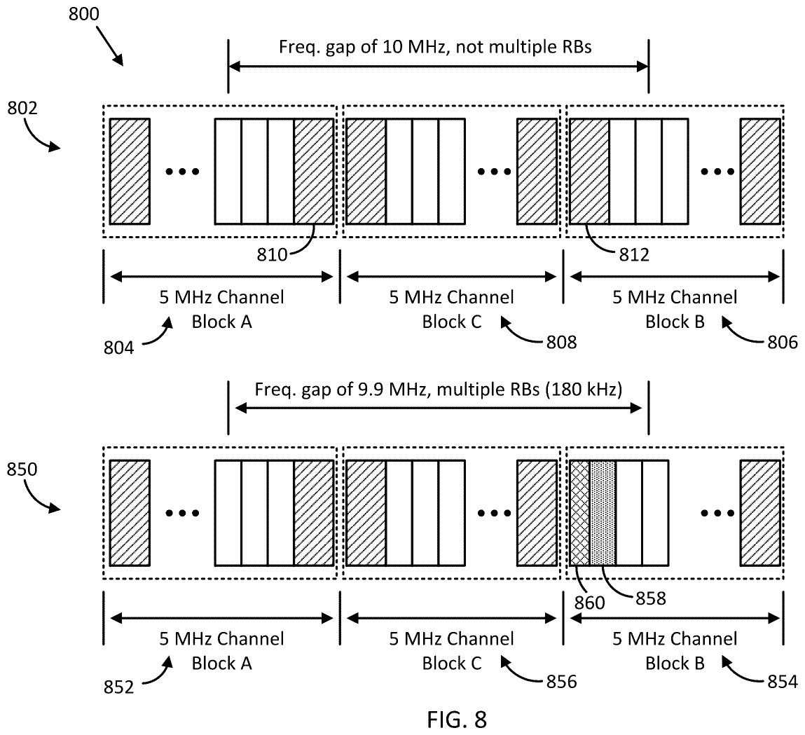

FIG. 8 illustrates example frequency block arrangements 800 in accordance with some embodiments. In particular, the frequency block arrangements 800 include a first frequency block arrangement 802 with non-contiguous frequency blocks not moved or shifted and a second frequency block arrangement 850 with non-contiguous frequency blocks being moved or shifted in accordance with the first approach.

The first frequency block arrangement 802 may include a first frequency block 804 (which may be referred to as “Block A”) and a second frequency block 806 (which may be referred to as “Block B”) that are configurable for a first UE. For example, the first frequency block 804 and the second frequency block 806 may be configured to the first UE in a fragmented carrier arrangement. The first frequency block 804 and the second frequency block 806 may be non-contiguous. Without either of the first frequency block 804 and the second frequency block 806 being shifted, a frequency gap of 10 MHz may exist between the first frequency block 804 and the second frequency block 806. The frequency gap of 10 MHZ may be a fractional multiple of an RB related to the first frequency block arrangement 802, which is not supported in legacy systems.

A third frequency block 808 (which may be referred to as “Block C”) may be located between the first frequency block 804 and the second frequency block 806. The third frequency block 808 may be configurable for a second UE by another operator. Without protection, transmissions within the third frequency block 808 may cause interference with transmissions within the first frequency block 804 and/or the second frequency block 806. To avoid the interference, GBs are included within the blocks. In particular, the first frequency block 804 includes a first GB 810 toward the third frequency block 808 and the second frequency block 806 includes a second GB 812 toward the third frequency block 808. The first GB 810 and the second GB 812 may be included to avoid interference with the third frequency block 808.

The second frequency block arrangement 850 may have a first frequency block and/or a second frequency block shifted to have a frequency gap between the frequency blocks being an integer multiple of an RB related to the second frequency block arrangement 850. For example, a base station may shift the first frequency block and/or the second frequency block in configuring a UE with the first frequency block and/or the second frequency block.

The second frequency block arrangement 850 may include a first frequency block 852 (which may be referred to as “Block A”) and a second frequency block 854 (which may be referred to as “Block B”) that are configurable for a first UE. For example, the first frequency block 852 and the second frequency block 854 may be configured to the first UE in a fragmented carrier arrangement. The first frequency block 852 and the second frequency block 854 may be non-contiguous. In the illustrated embodiment, the second frequency block 854 may be shifted to have a frequency gap between the first frequency block 852 and the second frequency block 854 be an integer multiple of an RB related to the second frequency block arrangement 850. In the illustrated embodiment, the second frequency block 806 may be shifted toward the first frequency block 852 with a frequency gap between the first frequency block 852 and the second frequency block 854 being 9.9 MHz. The 9.9 MHz gap may be an integer multiple of the RB.

A third frequency block 856 (which may be referred to as “Block C”) may be located between the first frequency block 852 and the second frequency block 854. The third frequency block 856 may be configurable for a second UE by another operator. To avoid interference between the third frequency block 856 and the second frequency block 854, a minimum GB of the size of the second GB 812 may be defined by specification. However, a first RB 858 may overlap with the specification defined minimum GB due to the shifting of the second frequency block 854, which would result in a reduced GB 860. To address this overlap, one or more of the following options may be implemented to address this overlap and ensure that interference does not occur between the third frequency block 856 and the second frequency block 854.

In a first option (which may be referred to as “Option 1”), a few RBs may be blanked at the edge of a frequency block, i.e., the RBs are not scheduled in the DL or uplink (UL). The sum of bandwidth of reduced GB and blanked RBs should be no less than minimum GB. For example, the first RB 858 may be unscheduled based on the first RB 858 overlapping with the specification defined minimum GB in accordance with the first option. The reduced GB 860 and the first RB 858 may be equal to or larger than the second GB 812, where the second GB 812 may be the specification defined minimum GB. The reduced GB 860 and the unscheduled first RB 858 being equal to or larger than the specification defined minimum GB may ensure that interference does not occur between the second frequency block 854 and the third frequency block 856. In configuring the UE, the base station may configure the first RB 858 as unscheduled.

In a second option (which may be referred to as “Option 2”), a UE capability may be introduced to UEs that can still meet the coexistence requirement, e.g., adjacent channel leakage ratio (ACLR)/spectrum emissions mask (SEM) in the UL and adjacent channel selectivity (ACS)/Blocking in the DL, with reduced GB. For example, the UE may be configured to generate and/or transmit a UE capability indication message to a base station. The support of the reduced GB can be part of the UE capability. For example, the UE capability indication message may include an indication of whether the UE supports a reduced GB. Both symmetrical and asymmetrical GB at both edges of the channel can be reported. For example, the UE capability indication message may include a symmetrical support indication that indicates a single size of GB for the GBs of the first frequency block 852 and second frequency block 854 adjacent to the third frequency block 856 in some embodiments. In other embodiments, the UE capability indication message may include an asymmetrical support indication that can indicate difference sizes for the GB of the first frequency block 852 adjacent to the third frequency block 856 and for the GB of the second frequency block 854 adjacent to the third frequency block 856.

The capability can be separated for UL and DL. For example, the UE capability indication can include a first indication for UL and a second indication for DL. For UL, the required power reduction can be part of the capability. For example, the UE capability indication may include an indication of whether power reduction is to be configured for the UL in some embodiments. For UEs supporting the capability, no RB blanking is needed, thereby increasing spectrum utilization. For example, if the UE associated with the second frequency block arrangement 850 supports a reduced GB, the first RB 858 may be scheduled with the reduced GB 860. For UEs not supporting the capability, RB blanking may be needed meaning reduced spectrum utilization. For example, if the UE associated with the second frequency block arrangement 850 does not support a reduced GB, the first RB 858 may be unscheduled with the reduced GB 860.

In a third option (which may be referred to as “Option 3”), for UL scheduling, UE transmission (TX) power can be lowered to help the UE to meet the coexistence requirements. For example, the base station may configure the UE with a reduced TX power. For the third option, the first RB 858 may be scheduled with a reduced TX power.

In a fourth option (which may be referred to as “Option 4”), for UL scheduling, only Block A is scheduled, as its minimum GB is not reduced. For example, the base station may configure only the first frequency block 852 for the UE and may omit the third frequency block 854 from the configuration for the UE for UL.

In a fifth option (which may be referred to as “Option 5”), options 1-4 can be used in combination. For example, one or more of the first option, the second option, the third option, and the fourth option may be implemented in some embodiments. The first approach can be extended to support more than two discontinuous frequency blocks in a carrier.

For a second approach (which may be referred to as “Approach 2”), separate BWPs may be configured for each block and both BWPs may be kept active. To share the same Point A and carrierBandwidth, Block B center frequency may be slightly moved to ensure the gap is multiple of RB bandwidth.

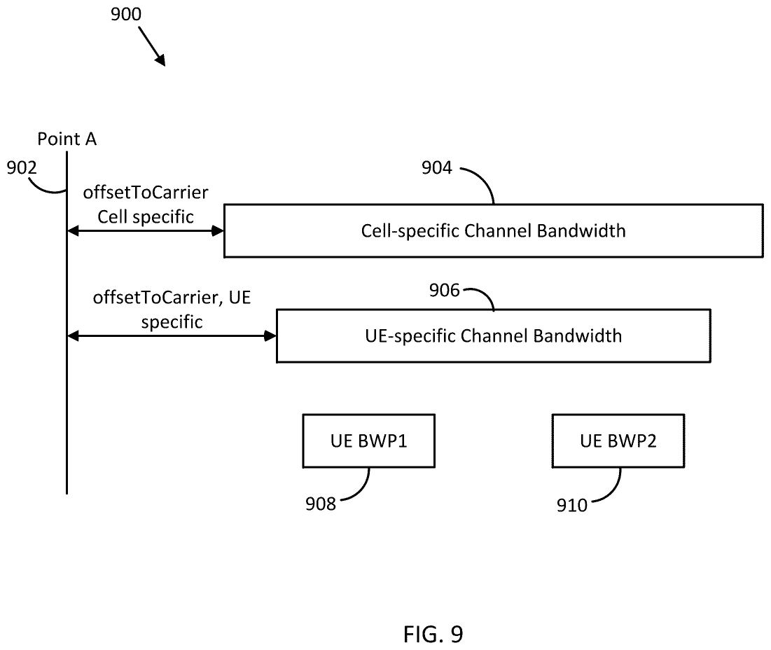

FIG. 9 illustrates an example frequency block arrangement 900 in accordance with some embodiments. For example, the arrangement 900 illustrates an example of a two BWP parts being configured to cover two non-contiguous frequency blocks in accordance with the second approach. The arrangement 900 illustrates a configuration that may be implemented related to a UE.

The arrangement 900 may include a reference point 902. The reference point 902 may be referred to as point A. The reference point 902 may be a point in which bandwidth configurations related to the UE are referenced. The reference point 902 may be utilized by a base station and/or a connected UE for coordinating scheduling of transmission of messages.

The arrangement 900 may include a first frequency block (such as the first frequency block 604 (FIG. 6)) and a second frequency block (such as the second frequency block 606 (FIG. 6)). The first frequency block and the second frequency block may be non-contiguous. The first frequency block and the second frequency block may be configurable for the UE, where the UE may utilize the frequencies within the first frequency block and/or the second frequency block when the blocks are configured to the UE.

The arrangement 900 includes a cell-specific channel bandwidth 904. The cell-specific channel bandwidth 904 may define a bandwidth for broadcasting by a base station hosting a cell. For example, the base station may transmit messages within the cell-specific channel bandwidth 904. The cell-specific channel bandwidth 904 may be offset from the reference point 902 by an offset to carrier cell specific value, which can be defined by an offset to carrier cell specific field of an information element.

The arrangement 900 includes a UE-specific channel bandwidth 906. The UE-specific channel bandwidth 906 may be a bandwidth that was configured for the particular UE. The UE-specific channel bandwidth 906 may be fully contained within the cell-specific channel bandwidth 904. The cell-specific channel bandwidth 904 may be offset from the reference point 902 by an offset to carrier cell specific value, which can be defined by an offset to carrier cell specific field of an information element.

The arrangement 900 includes a first UE BWP 908 and a second UE BWP 910. The first UE BWP 908 and the second UE BWP 910 may be configured for use by the UE. The first UE BWP 908 and the second UE BWP 910 may be fully contained within the UE-specific channel bandwidth 906 and may be smaller than the UE-specific channel bandwidth 906.

For the second approach, the first UE BWP 908 may be configured to cover the first frequency block and the second UE BWP 910 may be configured to cover the second frequency block. For example, the frequencies within the first frequency block may also be within the first UE BWP 908 and the frequencies within the second frequency block may also be within the second UE BWP 910. Further, the UE-specific channel bandwidth 906 may cover both the first frequency block and the second frequency block. The base station may configure the UE with the first UE BWP 908 that covers the first frequency block and the second UE BWP 910 that covers the second frequency block in the second approach.

Compared to approach 1 where only one large BWP is configured and activated, approach 2 has two active BWPs (BWP1 for Block A and BWP2 for Block B) so UE can use BWP specific filter setting for each active BWP and thus can potentially better meet the coexistence requirement, including ACLR/SEM and ACS/Blocking performance. For example, the first UE BWP 908 and the second UE BWP 910 may be active in the second approach. The first UE BWP 908 may use a first BWP specific filter setting and the second UE BWP 910 may use a second BWP specific filter setting, where the second BWP filter setting may be the same or different than the first BWP filter setting. Allowing the first UE BWP 908 and the second UE BWP 910 to have individual filter settings may assist in meeting the coexistence requirement between frequency blocks.

As with the first approach, the second approach may move and/or shift one the first frequency block and/or the second frequency block to have a gap between the first frequency block and the second frequency block be an integer multiple of an RB. The shifting of the first frequency block and/or the second frequency block may result in one or more RBs of the first frequency block and/or the second frequency block overlapping with the specification defined minimum GB (such as the overlap of the first RB 858 (FIG. 8) with the specification defined minimum GB). Proposed coexistence techniques and UE capability in approach 1 can be reused. For example, any one or more of the first option through the fifth option described above in regard to the first approach for addressing the overlap of the RB with the specification defined minimum GB may be implemented with the second approach.

Approach 2 can be extended to support more than two discontinuous frequency blocks in a carrier. For example, the second approach may be implemented for more than two discontinuous frequency blocks.

For a third approach (which may be referred to as “Approach 3”), separate BWPs may be configured for each block and both BWPs may be kept active. Block A and Block B center frequency may not be shifted. Like the second approach, there may be two configured and active BWPs (BWP1 for Block A and BWP2 for Block B).

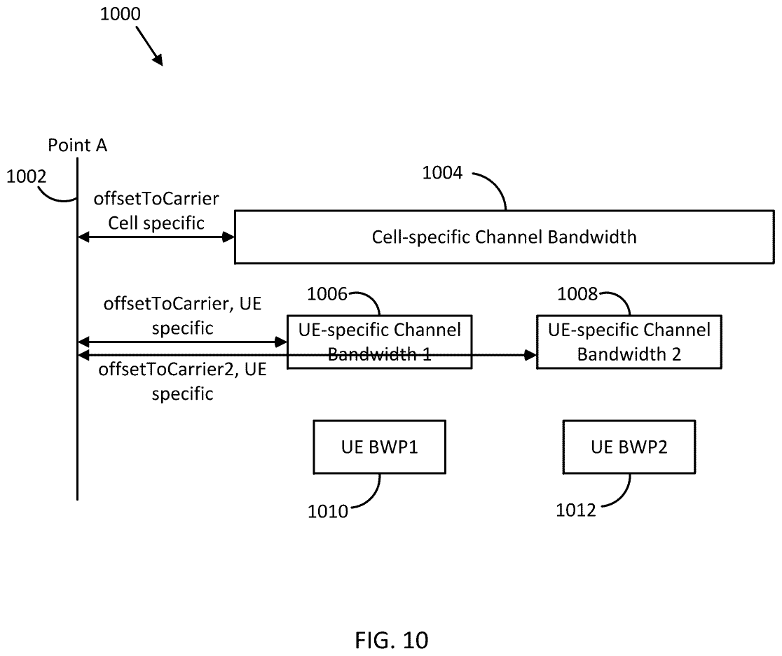

FIG. 10 illustrates an example frequency block arrangement 1000 in accordance with some embodiments. For example, the arrangement 1000 illustrates an example of two BWP parts being configured to cover two non-contiguous frequency blocks in accordance with the third approach. The arrangement 1000 illustrates a configuration that may be implemented related to a UE.

The arrangement 1000 may include a reference point 1002. The reference point 1002 may be referred to as point A. The reference point 1002 may be a point in which bandwidth configurations related to the UE are referenced. The reference point 1002 may be utilized by a base station and/or a connected UE for coordinating scheduling of transmission of messages.

The arrangement 1000 may include a first frequency block (such as the first frequency block 604 (FIG. 6)) and a second frequency block (such as the second frequency block 606 (FIG. 6)). The first frequency block and the second frequency block may be non-contiguous. The first frequency block and the second frequency block may be configurable for the UE, where the UE may utilize the frequencies within the first frequency block and/or the second frequency block when the blocks are configured to the UE.

The arrangement 1000 includes a cell-specific channel bandwidth 1004. The cell-specific channel bandwidth 1004 may define a bandwidth for broadcasting by a base station hosting a cell. For example, the base station may transmit messages within the cell-specific channel bandwidth 1004. The cell-specific channel bandwidth 1004 may be offset from the reference point 1002 by an offset to carrier cell specific value, which can be defined by an offset to carrier cell specific field of an information element.

The arrangement 1000 includes a first UE-specific channel bandwidth 1006 and a second UE-specific channel bandwidth 1008. The first UE-specific channel bandwidth 1006 and the second UE-specific channel bandwidth 1008 may be bandwidths that were configured for the particular UE. The first UE-specific channel bandwidth 1006 and the second UE-specific channel bandwidth 1008 may be fully contained within the cell-specific channel bandwidth 1004. The first UE-specific channel bandwidth 1006 may be offset from the reference point 1002 by a first offset to carrier cell specific value, which can be defined by a first offset to carrier cell specific field of an information element. The second UE-specific channel bandwidth 1008 may be offset from the reference point 1002 by a second offset to carrier cell specific value, which can be defined by a second offset to carrier cell specific field of an information element.

The arrangement 1000 includes a first UE BWP 1010 and a second UE BWP 1012. The first UE BWP 1010 and the second UE BWP 1012 may be configured for use by the UE. The first UE BWP 1010 may be fully contained within the first UE-specific channel bandwidth 1006 and may be smaller than the first UE-specific channel bandwidth 1006. The second UE BWP 1012 may be fully contained within the second UE-specific channel bandwidth 1008 and may be smaller than the second UE-specific channel bandwidth 1008.

For the second approach, the first UE BWP 1010 may be configured to cover both the first frequency block and the second UE BWP 1012 may be configured to cover the second frequency block. For example, the frequencies within the first frequency block may also be within the first UE BWP 1010 and the frequencies within the second frequency block may also be within the second UE BWP 1012. Further, the first UE-specific channel bandwidth 1006 may cover the first frequency block and the second UE-specific channel bandwidth 1008 may cover the second frequency block. The base station may configure the UE with the first UE BWP 1010 that covers the first frequency block and the second UE BWP 1012 that covers the second frequency block in the second approach.

As no center frequency is shifted for the third approach, for each BWP, the existing minimum GB can be reused. For example, the third approach may utilize the specification defined minimum GB for the first frequency block and the second frequency block. Two UE-specific channel bandwidths may be configured for the third approach. Approach 3 can be extended to support more than two discontinuous frequency blocks in a carrier. For example, the third approach may be implemented for more than two discontinuous frequency blocks.

To support the third approach, the information element (IE) SCS-SpecificCarrier may be revised as follows.
SCS-SpecificCarrier::=SEQUENCE {
   offsetToCarrier INTEGER (0 . . . 2199),
   offsetToCarrier2 ARFCN-ValueNR, OPTIONAL
   subcarrierSpacing SubcarrierSpacing,
carrierBandwidth INTEGER (1 . . . maxNrofPhysicalResourceBlocks),
   . . . ,
   [[
   txDirectCurrentLocation INTEGER (0 . . . 4095) OPTIONAL—Need S
   ]]
}

For example, a subcarrier spacing (SCS) specific carrier IE may be revised to include a second offset to carrier field. The second offset to carrier field may be optional and may accept an absolute radio frequency channel number (ARFCN). The second offset to carrier field may be utilized for defining an offset from the reference point 1002 for the second UE-specific channel bandwidth 1008. If offsetToCarrier2 is configured, it may override offsetToCarrier for the second UE-specific channel bandwidth 1008. The revised SCS specific carrier IE may be utilized for the third approach.

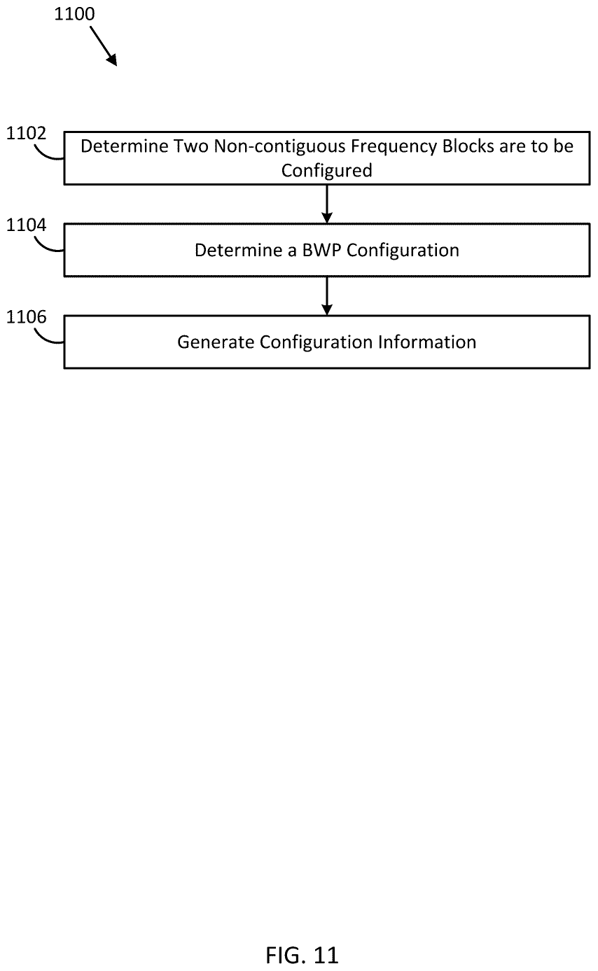

FIG. 11 illustrates an example procedure 1100 for generating configuration information in accordance with some embodiments. For example, configuration information may be generated for configuring a UE related to two non-contiguous frequency blocks. The procedure 1100 may be performed by a base station, such as the base station 108 (FIG. 1) and/or the network device 300 (FIG. 3).

The procedure 1100 may include determining two non-contiguous frequency blocks are to be configured in 1102. For example, the base station may determine two non-contiguous frequency blocks are to be configured for a UE.

The procedure 1100 may include determining a BWP configuration in 1104. For example, the base station may determine a BWP configuration related to the two non-contiguous frequency blocks.

In some embodiments, the BWP configuration may include a single BWP that covers frequencies of both of the two non-contiguous frequency blocks.

In some embodiments, the BWP configuration may include a first BWP that covers frequencies of a first frequency block of the two non-contiguous frequency blocks, and a second BWP that covers frequencies of a second frequency block of the two non-contiguous frequency blocks. In some of these embodiments, configuring the UE may include generating a configuration message for transmission to the UE that configures the UE with the BWP configuration. The configuration message may include a SCS specific carrier information element. The SCS specific carrier information element may include an offset carrier field for an absolute radio frequency channel number value.

In some embodiments, determining the BWP configuration may include determining that a gap between the two non-contiguous frequency blocks is a fractional multiple of an RB bandwidth, and determining to shift a frequency block of the two non-contiguous frequency blocks to have the gap be an integer multiple of the RB bandwidth. The BWP configuration may include the shifted frequency block.

In some embodiments, the procedure 1100 may further include identifying a UE capability indication from the UE that indicates whether a reduced guard band is supported by the UE. The BWP configuration may be determined based at least in part on the UE capability indication. In some of these embodiments, the UE capability indication may further indicate whether a power reduction is to be configured, and wherein the BWP configuration is determined based at least in part on whether the power reduction is to be configured.

In some embodiments, the procedure 1100 may further include determining that a portion of the frequency block overlaps with a minimum guard band requirement, wherein the BWP configuration has one or more of RBs of the frequency block that overlap the minimum guard band requirement unscheduled. The BWP configuration may include a transmission power reduction for uplink scheduling based at least in part on the shifted frequency block being included in the BWP configuration in some embodiments.

In some embodiments, determining the BWP configuration may include determining that a gap between the two non-contiguous frequency blocks is a fractional multiple of an RB bandwidth and determining that shifting a frequency block of the two non-contiguous frequency blocks conflicts with a minimum guard band requirement. Determining the BWP configuration may further include omitting the frequency block from the BWP configuration based at least in part on the shifting of the frequency block conflicting with the minimum guard band requirement in some embodiments.

The procedure 1100 may include generating configuration information in 1106. For example, the base station may generate configuration information to configure the UE with the BWP configuration.

Any one or more of the operations in FIG. 11 may be performed in a different order than shown and/or one or more of the operations may be performed concurrently in embodiments. Further, it should be understood that one or more of the operations may be omitted from and/or one or more additional operations may be added to the procedure 1100 in other embodiments.

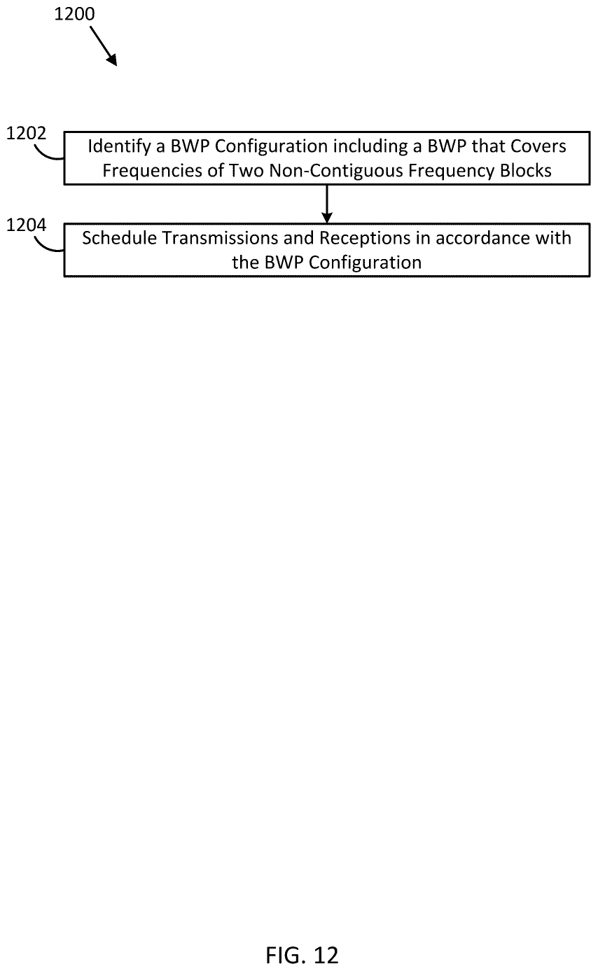

FIG. 12 illustrates an example procedure 1200 in accordance with some embodiments. The procedure 1200 may include scheduling transmissions in accordance with a BWP configuration related to two non-contiguous frequency blocks. The procedure 1200 may be performed by a UE, such as the UE 104 (FIG. 1), the UE 106 (FIG. 1), and/or the UE 200 (FIG. 2).

The procedure 1200 may include identifying a BWP configuration including a BWP that covers frequencies of two non-contiguous frequency blocks in 1202. For example, the UE may identify a BWP configuration related to two non-contiguous frequency blocks. The BWP configuration may include a BWP that covers frequencies of both of the two non-contiguous frequency blocks.

In some embodiments, the BWP configuration may include a frequency shift for a frequency block of the two non-contiguous frequency blocks to shift the frequency block to have a gap between the two non-contiguous frequency blocks that is an integer multiple of an RB bandwidth.

In some embodiments, the procedure 1200 may further include generating a capability indication message for transmission. The capability indication message may include an indication of whether a reduced guard band is supported. The BWP configuration may be based at least in part on the indication. In some of these embodiments, the capability indication message may include an indication of whether a power reduction is to be configured.

In some embodiments, the BWP configuration may include one or more RBs that are unscheduled based at least in part on the one or more RBs overlapping a minimum guard band requirement, or a transmission power reduction for uplink scheduling. The BWP configuration may omit a frequency block of the two non-contiguous frequency blocks based at least in part a reduced guard band not being supported.

The procedure 1200 may include scheduling transmissions and receptions in accordance with the BWP configuration in 1204.

Any one or more of the operations in FIG. 12 may be performed in a different order than shown and/or one or more of the operations may be performed concurrently in embodiments. Further, it should be understood that one or more of the operations may be omitted from and/or one or more additional operations may be added to the procedure 1200 in other embodiments.

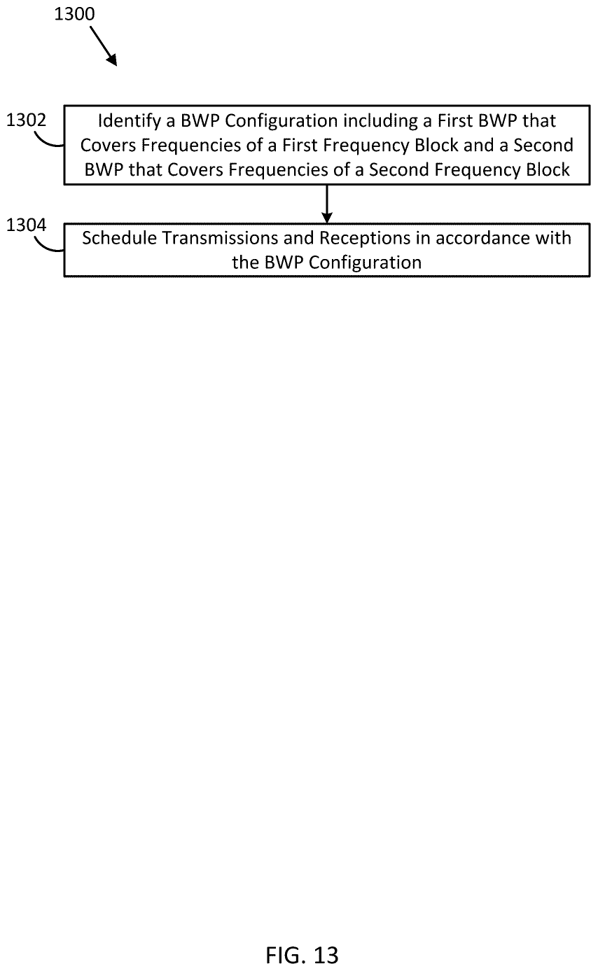

FIG. 13 illustrates an example procedure 1300 in accordance with some embodiments. The procedure 1300 may include scheduling transmissions in accordance with a BWP configuration related to two non-contiguous frequency blocks. The procedure 1300 may be performed by a UE, such as the UE 104 (FIG. 1), the UE 106 (FIG. 1), and/or the UE 200 (FIG. 2).

The procedure 1300 may include identifying a BWP configuration including a first BWP that covers frequencies of a first frequency block and a second BWP that covers frequencies of a second frequency block in 1302. For example, the UE may identify a BWP configuration related to two non-contiguous frequency blocks. The BWP configuration may include a first BWP that covers frequencies of a first frequency block and a second BWP that covers frequencies of a second frequency block.

In some embodiments, the BWP configuration may include an SCS specific carrier information element that includes an offset carrier for the second frequency block. The offset carrier may include an ARFCN value.

In some embodiments, the BWP configuration may include a frequency shift for the second frequency block to shift the second frequency block to have a gap between the two non-contiguous frequency blocks that is an integer multiple of an RB bandwidth. In some of these embodiments, the procedure 1300 may further include generating a capability indication message for transmission. The capability indication message may include an indication of whether a reduced guard band is supported. The BWP configuration may be based at least in part on the indication. In some of these embodiments, the BWP configuration may include one or more RBs that are unscheduled based at least in part on the one or more RBs overlapping a minimum guard band requirement, or a transmission power reduction for uplink scheduling.

In some embodiments, the BWP configuration may omit the second frequency block based at least in part on a reduced guard band not being supported.

The procedure 1300 may include scheduling transmissions and receptions in accordance with the BWP configuration in 1304.

Any one or more of the operations in FIG. 13 may be performed in a different order than shown and/or one or more of the operations may be performed concurrently in embodiments. Further, it should be understood that one or more of the operations may be omitted from and/or one or more additional operations may be added to the procedure 1300 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 may include a method comprising determining two non-contiguous frequency blocks are to be configured for a user equipment (UE), determining a bandwidth part (BWP) configuration related to the two non-contiguous frequency blocks, and generating configuration information to configure the UE with the BWP configuration.

Example 2 may include the method of example 1, wherein the BWP configuration includes a single BWP that covers frequencies of both of the two non-contiguous frequency blocks.

Example 3 may include the method of example 1, wherein the BWP configuration includes a first BWP that covers frequencies of a first frequency block of the two non-contiguous frequency blocks, and a second BWP that covers frequencies of a second frequency block of the two non-contiguous frequency blocks.

Example 4 may include the method of example 3, wherein configuring the UE includes generating a configuration message for transmission to the UE that configures the UE with the BWP configuration, wherein the configuration message includes a subcarrier spacing (SCS) specific carrier information element, and wherein the SCS specific carrier information element includes an offset carrier field for an absolute radio frequency channel number value.

Example 5 may include the method of example 1, wherein determining the BWP configuration includes determining that a gap between the two non-contiguous frequency blocks is a fractional multiple of a resource block (RB) bandwidth, and determining to shift a frequency block of the two non-contiguous frequency blocks to have the gap be an integer multiple of the RB bandwidth, wherein the BWP configuration includes the shifted frequency block.

Example 6 may include the method of example 5, further comprising identifying a UE capability indication from the UE that indicates whether a reduced guard band is supported by the UE, wherein the BWP configuration is determined based at least in part on the UE capability indication.

Example 7 may include the method of example 6, wherein the UE capability indication further indicates whether a power reduction is to be configured, and wherein the BWP configuration is determined based at least in part on whether the power reduction is to be configured.

Example 8 may include the method of example 5, further comprising determining that a portion of the frequency block overlaps with a minimum guard band requirement, wherein the BWP configuration has one or more of RBs of the frequency block that overlap the minimum guard band requirement unscheduled.

Example 9 may include the method of example 5, wherein the BWP configuration includes a transmission power reduction for uplink scheduling based at least in part on the shifted frequency block being included in the BWP configuration.

Example 10 may include the method of example 1, wherein determining the BWP configuration includes determining that a gap between the two non-contiguous frequency blocks is a fractional multiple of a resource block (RB) bandwidth, determining that shifting a frequency block of the two non-contiguous frequency blocks conflicts with a minimum guard band requirement, and omitting the frequency block from the BWP configuration based at least in part on the shifting of the frequency block conflicting with the minimum guard band requirement.

Example 11 may include a method comprising identifying a bandwidth part (BWP) configuration related to two non-contiguous frequency blocks, the BWP configuration including a BWP that covers frequencies of both of the two non-contiguous frequency blocks, and scheduling transmissions and receptions in accordance with the BWP configuration.

Example 12 may include the method of example 11, wherein the BWP configuration includes a frequency shift for a frequency block of the two non-contiguous frequency blocks to shift the frequency block to have a gap between the two non-contiguous frequency blocks that is an integer multiple of a resource block (RB) bandwidth.

Example 13 may include the method of example 12, further comprising generating a capability indication message for transmission, the capability indication message including an indication of whether a reduced guard band is supported, wherein the BWP configuration is based at least in part on the indication.

Example 14 may include the method of example 13, wherein the capability indication message includes an indication of whether a power reduction is to be configured.

Example 15 may include the method of example 12, wherein the BWP configuration includes one or more resource blocks (RBs) that are unscheduled based at least in part on the one or more RBs overlapping a minimum guard band requirement, or a transmission power reduction for uplink scheduling.

Example 16 may include the method of example 11, wherein the BWP configuration omits a frequency block of the two non-contiguous frequency blocks based at least in part a reduced guard band not being supported.

Example 17 may include a method comprising identifying a bandwidth part (BWP) configuration related to two non-contiguous frequency blocks, the BWP configuration including a first BWP that covers frequencies of a first frequency block and a second BWP that covers frequencies of a second frequency block, and scheduling transmissions and receptions in accordance with the BWP configuration.

Example 18 may include the method of example 17, wherein the BWP configuration includes a subcarrier spacing (SCS) specific carrier information element that includes an offset carrier for the second frequency block, the offset carrier including an absolute radio frequency channel number (ARFCN) value.

Example 19 may include the method of example 17, wherein the BWP configuration includes a frequency shift for the second frequency block to shift the second frequency block to have a gap between the two non-contiguous frequency blocks that is an integer multiple of a resource block (RB) bandwidth.

Example 20 may include the method of example 19, further comprising generating a capability indication message for transmission, the capability indication message including an indication of whether a reduced guard band is supported, wherein the BWP configuration is based at least in part on the indication.

Example 21 may include the method of example 19, wherein the BWP configuration includes one or more resource blocks (RBs) that are unscheduled based at least in part on the one or more RBs overlapping a minimum guard band requirement, or a transmission power reduction for uplink scheduling.

Example 22 may include the method of example 17, wherein the BWP configuration omits the second frequency block based at least in part on a reduced guard band not being supported.

Example 23 may include an apparatus comprising means to perform one or more elements of a method described in or related to any of examples 1-22, or any other method or process described herein.

Example 24 may include one or more non-transitory computer-readable media comprising instructions to cause an electronic device, upon execution of the instructions by one or more processors of the electronic device, to perform one or more elements of a method described in or related to any of examples 1-22, or any other method or process described herein.

Example 25 may include an apparatus comprising logic, modules, or circuitry to perform one or more elements of a method described in or related to any of examples 1-22, or any other method or process described herein.

Example 26 may include a method, technique, or process as described in or related to any of examples 1-22, or portions or parts thereof.

Example 27 may include an apparatus comprising: one or more processors and one or more computer-readable media comprising instructions that, when executed by the one or more processors, cause the one or more processors to perform the method, techniques, or process as described in or related to any of examples 1-22, or portions thereof.

Example 28 may include a signal as described in or related to any of examples 1-22, or portions or parts thereof.

Example 29 may include a datagram, information element, packet, frame, segment, PDU, or message as described in or related to any of examples 1-22, or portions or parts thereof, or otherwise described in the present disclosure.

Example 30 may include a signal encoded with data as described in or related to any of examples 1-22, or portions or parts thereof, or otherwise described in the present disclosure.

Example 31 may include a signal encoded with a datagram, IE, packet, frame, segment, PDU, or message as described in or related to any of examples 1-22, or portions or parts thereof, or otherwise described in the present disclosure.

Example 32 may include an electromagnetic signal carrying computer-readable instructions, wherein execution of the computer-readable instructions by one or more processors is to cause the one or more processors to perform the method, techniques, or process as described in or related to any of examples 1-22, or portions thereof.

Example 33 may include a computer program comprising instructions, wherein execution of the program by a processing element is to cause the processing element to carry out the method, techniques, or process as described in or related to any of examples 1-22, or portions thereof.

Example 34 may include a signal in a wireless network as shown and described herein.

Example 35 may include a method of communicating in a wireless network as shown and described herein.

Example 36 may include a system for providing wireless communication as shown and described herein.

Example 37 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying two non-contiguous frequency blocks that are to be configured for a user equipment (UE);
identifying a bandwidth part (BWP) configuration related to the two non-contiguous frequency blocks; and
generating configuration information to configure the UE with the BWP configuration.

2. The method of claim 1, wherein the BWP configuration includes a single BWP that covers frequencies of both of the two non-contiguous frequency blocks.

3. The method of claim 1, wherein the BWP configuration includes:
a first BWP that covers frequencies of a first frequency block of the two non-contiguous frequency blocks; and
a second BWP that covers frequencies of a second frequency block of the two non-contiguous frequency blocks.

4. The method of claim 3, wherein configuring the UE includes:
generating a configuration message for transmission to the UE that configures the UE with the BWP configuration, wherein the configuration message includes a subcarrier spacing (SCS) specific carrier information element, and wherein the SCS specific carrier information element includes an offset carrier field for an absolute radio frequency channel number value.

5. The method of claim 1, wherein determining the BWP configuration includes:
identifying that a gap between the two non-contiguous frequency blocks is a fractional multiple of a resource block (RB) bandwidth; and
determining to shift a frequency block of the two non-contiguous frequency blocks to have the gap be an integer multiple of the RB bandwidth, wherein the BWP configuration includes the shifted frequency block.

6. The method of claim 5, further comprising:
identifying a UE capability indication from the UE that indicates whether a reduced guard band is supported by the UE, wherein the BWP configuration is determined based at least in part on the UE capability indication.

7. The method of claim 6, wherein the UE capability indication further indicates whether a power reduction is to be configured, and wherein the BWP configuration is determined based at least in part on whether the power reduction is to be configured.

8. The method of claim 5, further comprising determining that a portion of the frequency block overlaps with a minimum guard band requirement, wherein the BWP configuration has one or more of RBs of the frequency block that overlap the minimum guard band requirement unscheduled.

9. The method of claim 5, wherein the BWP configuration includes a transmission power reduction for uplink scheduling based at least in part on the shifted frequency block being included in the BWP configuration.

10. The method of claim 1, wherein determining the BWP configuration includes:
identifying that a gap between the two non-contiguous frequency blocks is a fractional multiple of a resource block (RB) bandwidth;
determining that shifting a frequency block of the two non-contiguous frequency blocks conflicts with a minimum guard band requirement; and
omitting the frequency block from the BWP configuration based at least in part on the shifting of the frequency block conflicting with the minimum guard band requirement.

11. A method comprising:
identifying a bandwidth part (BWP) configuration related to two non-contiguous frequency blocks, the BWP configuration including a BWP that covers frequencies of both of the two non-contiguous frequency blocks; and
processing transmissions and receptions in accordance with the BWP configuration.

12. The method of claim 11, wherein the BWP configuration includes a frequency shift for a frequency block of the two non-contiguous frequency blocks to shift the frequency block to have a gap between the two non-contiguous frequency blocks that is an integer multiple of a resource block (RB) bandwidth.

13. The method of claim 12, further comprising:
generating a capability indication message for transmission, the capability indication message including an indication of whether a reduced guard band is supported, wherein the BWP configuration is based at least in part on the indication.

14. The method of claim 12, wherein the BWP configuration includes:
one or more resource blocks (RBs) that are unscheduled based at least in part on the one or more RBs overlapping a minimum guard band requirement; or
a transmission power reduction for uplink scheduling.

15. The method of claim 11, wherein the BWP configuration omits a frequency block of the two non-contiguous frequency blocks based at least in part a reduced guard band not being supported.

16. One or more non-transitory, computer-readable media having instructions that, when executed, cause processing circuitry to:
identify a bandwidth part (BWP) configuration related to two non-contiguous frequency blocks, the BWP configuration including a first BWP that covers frequencies of a first frequency block and a second BWP that covers frequencies of a second frequency block; and
schedule transmissions and receptions in accordance with the BWP configuration.

17. The one or more non-transitory, computer-readable media of claim 16, wherein the BWP configuration includes a subcarrier spacing (SCS) specific carrier information element that includes an offset carrier for the second frequency block, the offset carrier including an absolute radio frequency channel number (ARFCN) value.

18. The one or more non-transitory, computer-readable media of claim 16, wherein the BWP configuration includes a frequency shift for the second frequency block to shift the second frequency block to have a gap between the two non-contiguous frequency blocks that is an integer multiple of a resource block (RB) bandwidth.

19. The one or more non-transitory, computer-readable media of claim 18, wherein the instructions, when executed, further cause the processing circuitry to:
generate a capability indication message for transmission, the capability indication message including an indication of whether a reduced guard band is supported, wherein the BWP configuration is based at least in part on the indication.

20. The one or more non-transitory, computer-readable media of claim 18, wherein the BWP configuration includes:
one or more resource blocks (RBs) that are unscheduled based at least in part on the one or more RBs overlapping a minimum guard band requirement; or
a transmission power reduction for uplink scheduling.
